(19) United States
(12) Patent Application Publication
(10) Pub. No.: US 2011/0014326 A1
(43) Pub. Date: Jan. 20, 2011

(54) FILTERBAG AND METHOD OF BREWING COFFEE, TEA, AND THE LIKE IN A FRENCH PRESS

(76) Inventor: Ann Sofie Forssling, Slagelse (DK)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/922,297

(22) PCT Filed: Apr. 2, 2009
(86) PCT No.: PCT/DK09/00080

§ 371 Date: Sep. 13, 2010

(30) Foreign Application Priority Data
Apr. 7, 2008 (DK) PA 2008 00500

(51) Int. Cl. B65B 29/02; A23F 5/26; A23F 3/18

(52) U.S. Cl. 426/81; 426/433; 426/435

(57) ABSTRACT

A filter bag and method of brewing coffee, tea or the like in a French press. The bag is made of a material penetrable by water, but not by solid particles. The method comprises the steps of: Removing the plunger from the French press, placing the bag into the French press with the opening facing up, placing ground coffee beans, tea leaves or the like in the filter bag and pouring hot liquid into the bag. Then, the plunger is mounted on the French press as in ordinary use, just as the beverage steeps as it normally does. Then, the plunger is pushed down, emptying the filter bag of liquid and leaving the filter bag at the bottom of the French press. By means of the method it is achieved that smaller particles can be filtered out than is possible with the prior art French press, meaning that there are fewer grounds in the beverage. Also, the coffee grounds or tea leaves are contained in a way that allows for their quick and easy disposal, which makes it easier to clean the French press after use.

### FIELD OF THE INVENTION

The invention is a filter bag used when brewing hot beverages such as coffee and tea in a French press. The filter bag is used to contain the coffee grounds or tea leaves to prevent them from mixing with the beverage. Furthermore, using the filter bag eases the cleaning of the French press as removing the filter bag containing the coffee grounds or tea leaves is quick and easy. Finally, using the filter bag reduces the level of unhealthy fats such as kahweol and cafestol found in coffee as they are filtered out by the filter bag.

### THE TECHNIQUE'S BACKGROUND

When brewing coffee or tea in a French press, the metal filter mounted on the plunger for filtering out the coffee grounds or tea leaves from the beverage is normally used. However, small amounts of grounds still remain in the coffee/tea.

After brewing coffee or tea in the French press, it is necessary to manually clean the inside of the French press as it is filled with coffee grounds or tea leaves. There is no known quick and easy solution to this messy problem.

Coffee brewed in a French press leaves behind unhealthy fats such as kahweol and cafestol in the beverage. There is no known solution to this technical problem.

### UNIQUE FEATURES OF THE INVENTION

Using the filter bag when brewing coffee or tea means that the beverage is filtered through the filter bag, which results in no grounds in the coffee/tea. The filtering process occurs when the plunger is pushed down into the French press and the liquid passes through the filter bag.

The filter bag contains the coffee grounds or tea leaves, which allows for their easy removal by simply removing the filter bag from the French press and disposing of it. The French press then only requires a minimal amount of cleaning after use.

The filter bag filters out unhealthy fats like kahweol and cafestol in the same way as an ordinary coffee filter does when coffee is brewed with hot water running over the ground coffee beans, through a coffee filter and into a jug or other container. Thus, coffee brewed using the filter bag is as equally as healthy as coffee brewed the old-fashioned way.

### NEW TECHNICAL FEATURES

The invention comprises a filter bag to be used when brewing hot beverages such as coffee or tea in a French press.

In addition, the purpose is to filter out the coffee grounds and tea leaves to prevent them from getting mixed in with the beverage.

In addition, the purpose is to contain the coffee grounds or tea leaves to allow for their easy disposal and so that no coffee grounds or tea leaves remain in the French press after use. This eases the cleaning process of the French press after use.

Finally, the purpose of the filter bag is to filter out unhealthy fats such as kahweol and cafestol.

### TECHNICAL IMPLICATIONS

The filter bag is placed in the bottom of the French press with the opening facing up—coffee grounds, tea leaves or the like are added into the filter bag whereupon the liquid is poured over the coffee grounds, tea leaves or the like. The filter bag is closed, for instance, by folding the four flaps on the top of the filter bag. The steeping procedure for the beverage is the same as when normally making a beverage in a French press. After the beverage steeps, the plunger is pushed down so that the filter bag containing the coffee grounds, tea leaves or the like are left at the bottom of the French press under the plunger. The beverage is now ready for consumption. Afterwards, the plunger is pulled out of the French press and the filter bag containing the coffee grounds or tea leaves can be removed.

The material the filter bag is made of, for example, filter paper, fabric or polymers, filters out the small particles the metal filter in an ordinary French press does not collect. Consequently, the beverage is void of the grounds which normally settle at the bottom of the cup when served.

The filter bag, which contains all the coffee grounds, tea leaves or the like, is easy to remove from the French press—for instance by turning it upside down—when there is no more liquid in it. The French press is now easy to clean because there is no loose debris from the coffee grounds, tea leaves etc. left in the French press.

Unlike the original metal filter in the French press, the material the filter bag is made of, for example, filter paper, fabric or polymers, is able to filter unhealthy fats like kahweol and cafestol out of the beverage.

### LIST OF FIGURES

FIG. 1: Sketch of an example of the design of a filter bag.

FIG. 2: Picture of an example of a filter bag placed in a French press.

FIG. 3: Picture of an example of a filter bag used for brewing coffee in a French press. The picture is taken after the plunger has been pushed down.

### EMBODIMENT OF THE INVENTION

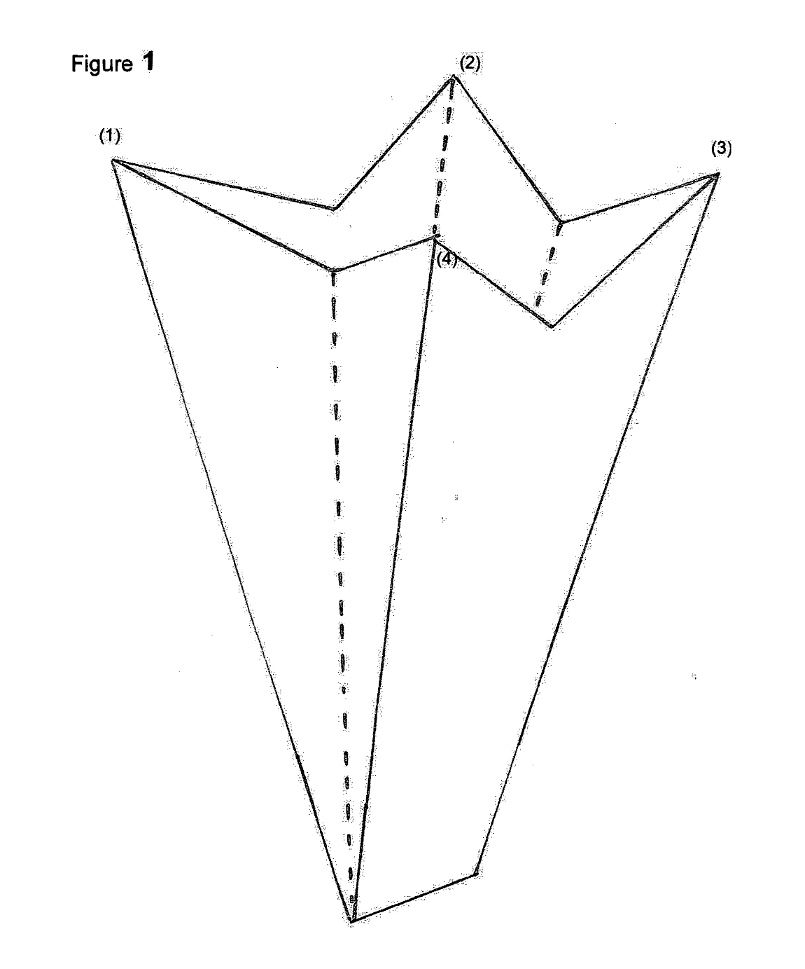

FIG. 1 shows an example of a potential filter bag design, e.g., a cylindrical filter bag with four flaps on top designed to close the filter bag before mounting the French press' filter assembly.

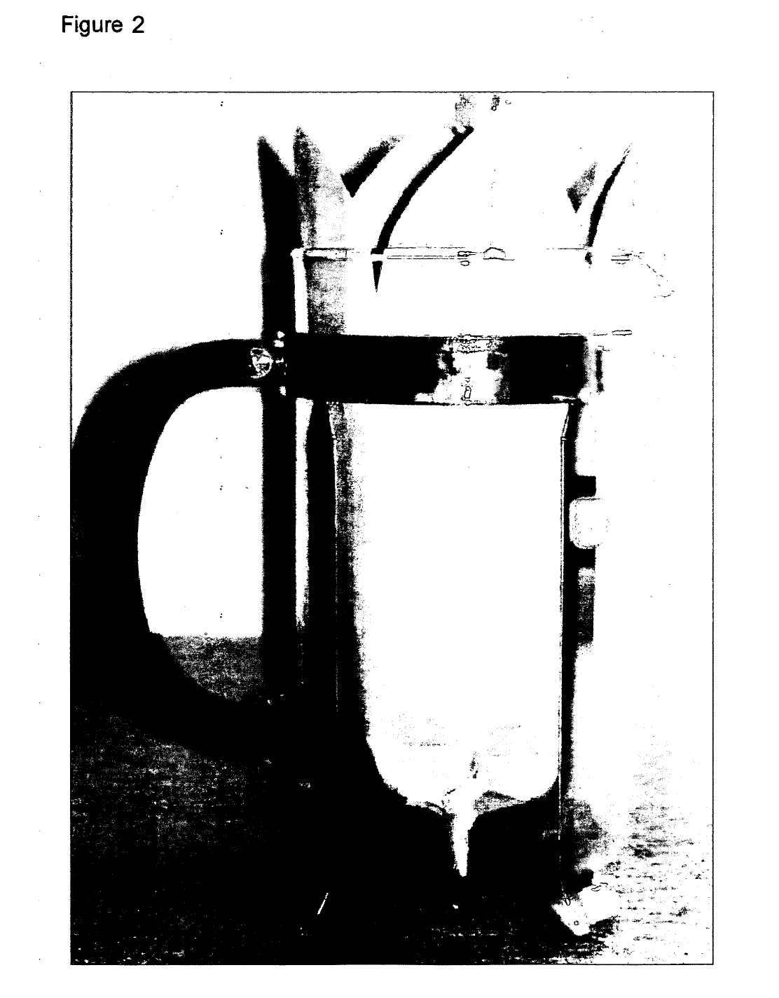

FIG. 2 shows a filter bag placed in a French press.

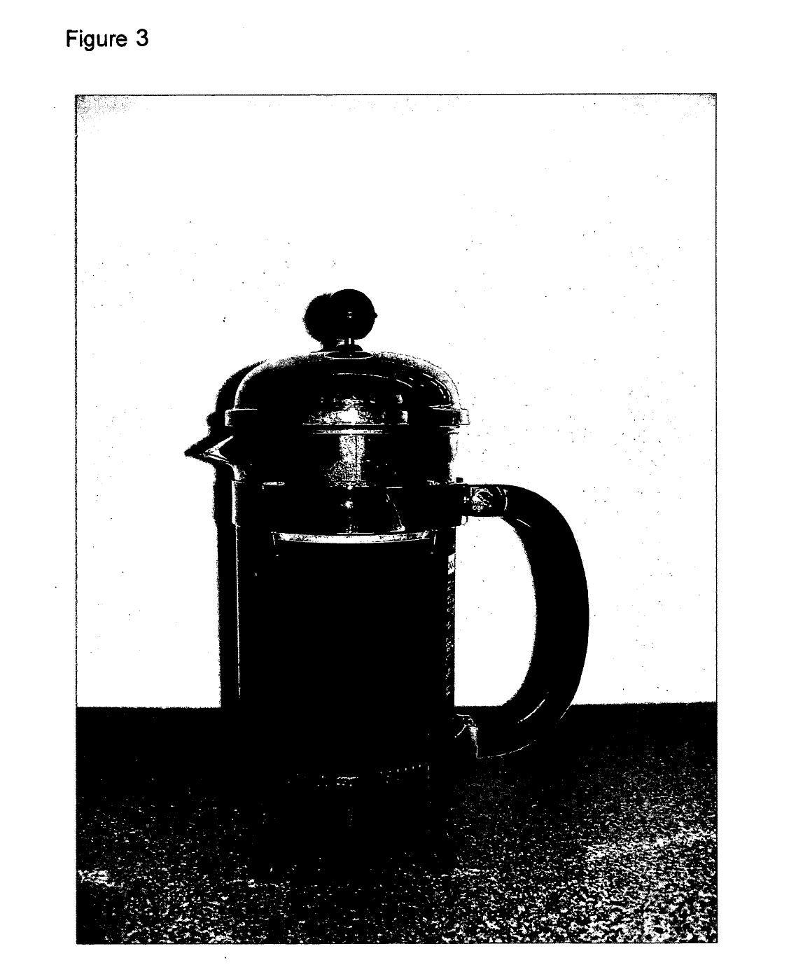

FIG. 3 shows a filter bag in use after the plunger has been pushed down.

1. Aid for brewing coffee, tea or the like in a French press. The aid is a filter bag that keeps coffee grounds, tea leaves or the like contained during the brewing process and is produced of a material penetrable by water but not by solid particles. The filter bag can be designed as shown in FIG. 1, e.g. where the filter bag is closed after adding the coffee grounds and tea leaves by using four foldable flaps, an adjustable lid, metal or plastic clip or the like.

2. Method of brewing coffee, tea or the like in a French press in which:
the plunger is removed from the French press,
a filter bag produced out of a material penetrable by water but not by solid particles is placed into the French press with the opening facing up,
ground coffee beans, tea leaves or the like are placed in the filter bag,
hot liquid is poured into the French press,
the filter bag is closed with the closing device,
the plunger is mounted on the French press,
the beverage steeps until the desired strength or taste has been reached,
the plunger is pushed down into the French press until the filter bag is emptied of liquid and pushed down into the bottom of the French press,
the beverage can now be enjoyed and afterwards the filter bag can be disposed of by simply removing it from the French press.
FIG. 1 shows a potential filter bag design.

3. Filter bag for brewing coffee, tea or the like according to claim no. 1 in which the filtering method leaves no coffee grounds or tea leaves in the beverage.

4. Filter bag for brewing coffee, tea or the like according to claim no. 1 where the new method makes cleaning the French press after use easier and quicker.

5. Filter bag for brewing coffee, tea or the like according to claim no. 1 where the filter bag removes unhealthy fats such as kahweol and cafestol.
